(19) United States
(12) Patent Application Publication
(10) Pub. No.: US 2004/0198329 A1
(43) Pub. Date: Oct. 7, 2004

(54) Mobile-initiated number information query and delivery

(76) Inventor: Yojak Vasa, Morrisville, NC (US)

Correspondence Address: COATS & BENNETT, PLLC, P O BOX 5, RALEIGH, NC, 27602, US

(21) Appl. No.: 10/260,987

(22) Filed: Sep. 30, 2002

(51) Int. Cl. H04M 3/42; H04M 3/00; H04Q 7/20

(52) U.S. Cl. 455/414.1; 455/418; 455/466

(57) ABSTRACT

A method of operation enables a mobile station or other wireless communication device to query a supporting wireless communication network for directory listing information associated with a phone number specified by the query. Preferably, the mobile station issues the query using short-messaging services (SMS) or other text messaging facilities supported by the network and may specify a desired data format as part of its query. The network returns a short-messaging response to the mobile station that includes one or more data items, such as directory listing information, associated with the specified phone number. The range of information returned may be altered or expanded to include promotional information, coupons, sales notices, etc., where the queried number is a commercial listing. The mobile station may initiate such queries responsive to the user dialing a number, as part of updating stored contact lists, or based on the user's initiation.

### BACKGROUND OF THE INVENTION

The present invention relates generally to mobile communication networks, and more particularly, to a method of querying a network database from a mobile station to obtain contact information.

Users of personal communication devices, such as cellular telephones, wireless Personal Digital Assistants (PDAs), and other wireless communication devices, benefit tremendously by their ability to use and store various types of contact information. Contact lists, such as electronic phone or address books allow users of such devices to conveniently store and dial numbers of interest. However, maintaining and updating such contact lists can be tedious at times. For example, a common cellular phone function recognizes when a user dials a “new” number not currently stored in the phone's contact list. Based on such recognition, the phone queries the user as to whether the number should be saved in the contact list for future use. If the user responds affirmatively, the phone adds the new number to the stored contacts list for future use. Of course, the number is stored without benefit of additional directory listing information, e.g., the name/address associated with the number, so the user must often engage in tedious data entry to input complete information for the automatically saved number.

In a typical scenario, the user calls a directory assistance service provided by his or her wireless service provider and is verbally told the number corresponding to a person or business identified by the user. Although such directory assistance services offer automated call completion to the requested number, many users avoid the additional charges associated with such automated call completion by completing the call on their own. As noted, where the wireless device recognizes the number being dialed as a new number, it generally prompts the user for associated data items such as name and address. Thus, the user ends up manually entering the directory information for the number just obtained from the directory assistance center.

### BRIEF SUMMARY OF THE INVENTION

The present invention provides a method and apparatus enabling mobile-initiated queries of a supporting wireless network for contact information, such as directory listing information. In an exemplary embodiment, a mobile station originates a Short Messaging Services (SMS) request message that specifies a telephone number for which additional information is desired. Upon receiving the request, the network accesses one or more databases, or cooperates with other entities to access the appropriate database(s) and returns one or more data items associated with the telephone number identified in the mobile station's request message. The mobile-initiated request may further specify the particular information desired for the number, and may specify the data format(s) in which the information should be returned by the network. For example, a mobile station might generate an SMS request that identifies a telephone number for which vCard formatted contact information is desired.

In an exemplary embodiment, a mobile station, such as a wireless cellular telephone or wireless PDA, recognizes that the user has entered or otherwise dialed a number not currently stored in its contact list. Based on this recognition, the device queries the user to determine whether the user wishes to save the number into the contact list, and, if so, whether the user wishes the device to obtain and store contact information associated with that number. If the user indicates that such contact information is desired, the device generates a SMS request that identifies the number of interest and may additionally specify the information desired and the data format in which the network should return the information.

The network processes the request received from the device, such as by processing the request at a Short Messaging Services Center (SMSC) or other appropriate network entity, and obtains one or more data items associated with the specified telephone number for return to the initiating device. In support of this data retrieval, the network may access directory listing databases, as well as other databases, both internal and external to the network, as needed or desired. For example, third-party service providers may maintain custom databases related to advertising and sales, e.g., electronic coupons, restaurant menus, etc., that are returned to the device if the queried number is a business number.

### BRIEF DESCRIPTION OF THE DRAWINGS

FIG. 1 illustrates an exemplary wireless communication network providing wireless communication services.

FIG. 2 illustrates an exemplary mobile station served by the wireless communication network of FIG. 1.

FIG. 3 illustrates exemplary operation of the mobile station according to the present invention.

FIG. 4 illustrates exemplary operation of the mobile station regarding retrieval of information for new numbers.

FIG. 5 illustrates an exemplary data record configuration for stored contact information in the mobile station.

FIG. 6 illustrates another exemplary embodiment of the network of FIG. 1.

### DETAILED DESCRIPTION OF THE INVENTION

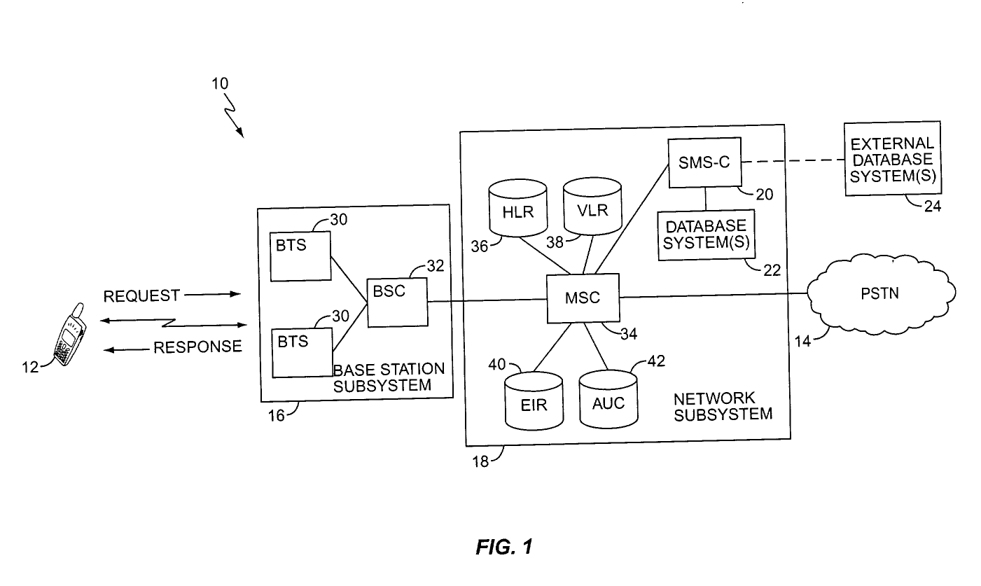

FIG. 1 illustrates a short-messaging services (SMS) system implemented as a wireless communication network 10. Of course, network 10 provides primary communication services that allow a user of a mobile station 12 to communicate with users of the Switch Telephone Network (PSTN) 14. A base station subsystem (BSS) 16 in combination with a network subsystem 18 supports communication between the mobile station 12 and the PSTN 14. Of particular interest with regard to the present invention, network subsystem 18 includes a Short Messaging Services Center (SMSC) 20 having access to one or more database systems, such as network database system 22 and/or external database systems 24. SMSC 20 generally supports short messaging services, e.g., text/data messaging to and from mobile station 12.

These SMS communications as well as voice/data communications to and from PSTN 14 involve wireless signaling between mobile station 12 and BSS 16. In support of such signaling, BSS 16 typically comprises one or more Base Transceiver Systems (BTSs) 30 that are communicatively coupled to one or more Base Station Controllers (BSCs) 32. In turn, the BSC 32 communicatively links the BSS 16 with a Mobile Switching Center (MSC) 34, which is communicatively coupled to SMSC 20 and various other network entities. Such entities typically include a Home Location Register (HLR) 36, a Visitor Location Register (VLR) 38, an Equipment Identification Register (EIR) 40, and an Authentication Center (AuC) 42. As illustrated, the architecture of network 10 is consistent with an implementation based on Global System for Mobile communications (GSM) standards but those skilled in the art should appreciate that the present invention is in no way limited to GSM implementations.

In accordance with the present invention, mobile station 12 initiates an SMS request, which request includes or otherwise identifies a telephone number for which additional information is desired. Thus, the present invention in its broadest sense comprises a mobile-initiated information request, which is acted on by the network 10 such that the mobile station 12 receives one or more data items in the form of an SMS response generated by the network responsive to the mobile station-originated request.

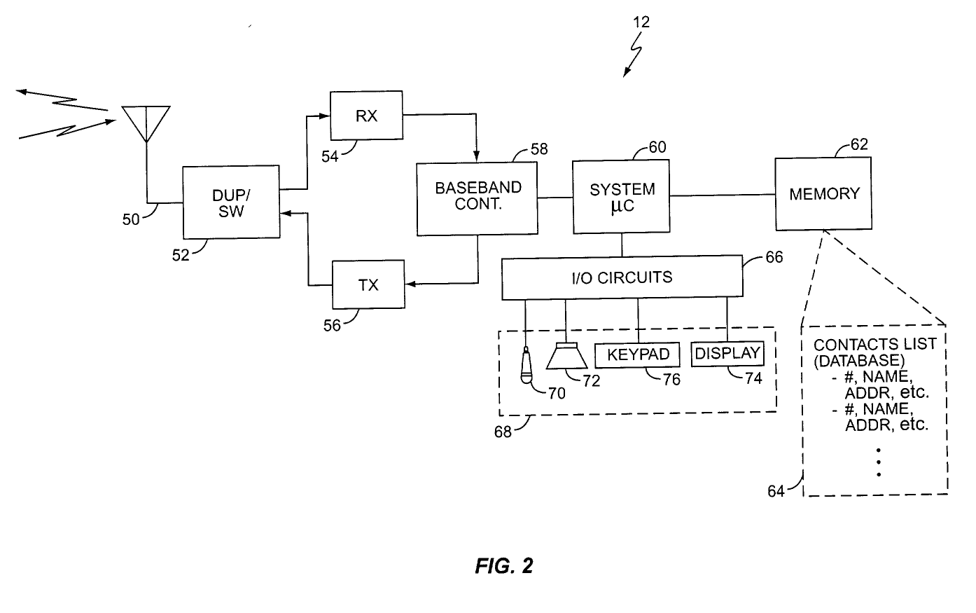

FIG. 2 illustrates a typical mobile station 12, although those skilled in the art will appreciate that the architecture of the mobile station 12 may vary significantly depending on the type of mobile station 12. The mobile station 12 illustrated in FIG. 2 is a fully functional cellular radio transceiver, the design of which is well known in the art. The mobile station 12 comprises an antenna 50, an antenna interface circuit 52, a receiver 54, a transmitter 56, a baseband controller 58, a system microcontroller or microprocessor 60, one or more memory devices or systems 62, stored information such as a contact list 64 held in memory 62, and one or more I/O circuits 66 coupling the system controller 60 to a user interface 68, which generally comprises a microphone 70, an audio speaker 72, a display 74, and a keypad 76.

In an exemplary operation, a user of the mobile station 12 initiates an information request associated with a phone number of interest, mobile station 12 generates the appropriate SMS request including identification of the phone number of interest, receives an SMS response from the network 10 including one or more data items associated with the phone number, and updates its memory 62 with the received information. Such updating may comprise storage of the received data items in non-volatile portions of memory 62, such as a contacts list 64, or may simply include updating working memory that is used to supply information for output on the display 74. Thus, the user may request contact information and have that information displayed for temporary use, permanently stored for subsequent retrieval, or some combination thereof.

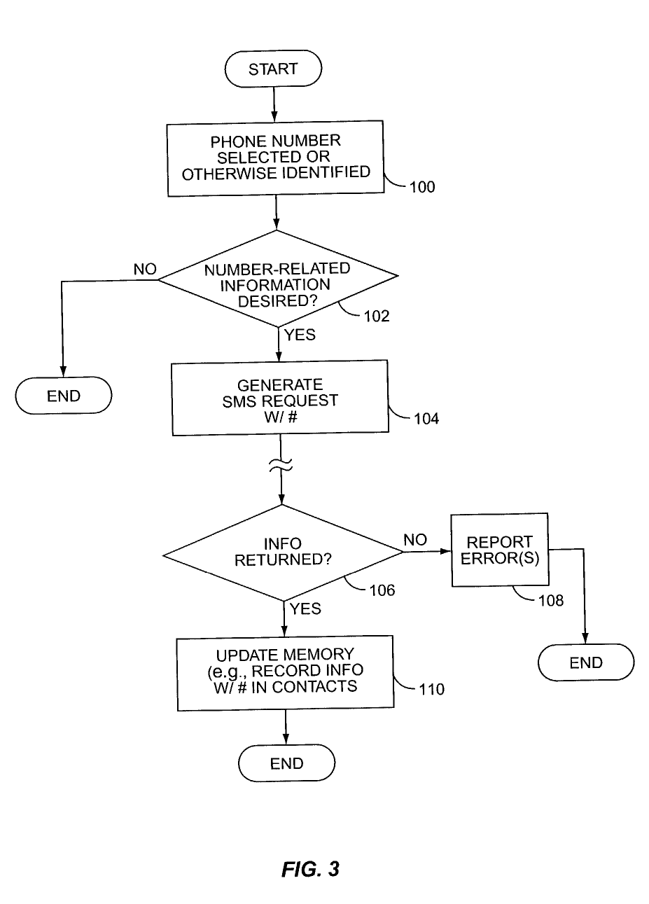

FIG. 3 illustrates the operation of the mobile station 12 in one exemplary embodiment of the invention. FIG. 3 illustrates a generalized process for initiating an SMS number information request and can be readily modified by those skilled in the art for added functionality. Processing starts with the identification or selection of a phone number of interest by the user (Step 100). If contact information is desired for the phone number (Step 102), the mobile station 12 generates an SMS request, with the generated request including or otherwise identifying the phone number of interest (Step 104). If number related information is not desired, processing ends with respect to SMS processing.

Absent errors or unavailability of information, network 10 returns an SMS message responsive to the mobile-initiated information request. Thus, based on whether the requested information is returned (Step 106), the mobile station 12 either provides an error report or some other indication to the user (Step 108), or updates its memory with the received information (Step 110). The mobile station 12 may update memory used for display output to the user and/or update the contact list 64 stored in memory 62.

As used in this discussion, the term “SMS message” should be construed broadly. For example, within GSM networks, SMS messages typically comprise 160-character text messages sent using slow speed data channels (SDCCH) that minimize network overhead and do not require allocation of dedicated data channels to the mobile stations 12. In the context of GSM, SMS messages may be sent or received concurrently with other active communications, such as during an active voice call. However, it should be understood that the present invention contemplates broad application across a range of network types, each possibly having its own specific implementations of SMS services, short text messaging services, or similar messaging services. Thus, as will be detailed later herein, the present invention may be utilized in a range of network types and messaging services. Therefore, the term “SMS message” as used herein is not limited to GSM-based details and should be given broad construction.

Message formats and the type of data transmitted and returned as part of the mobile-initiated information request of the present invention represent another area of broad variation. For example, in at least one exemplary embodiment, the request generated by mobile station 12 specifies the data format that should be used for information returned by network 10 in its response. Exemplary formats include vCard and vCalendar formats, which represent standard contact and calendaring information formats defined by the Internet Mail Consortium, which maintains an informational Web site at www.imc.org. Interested readers may obtain additional information concerning vCard in the standards documents RFC2425 and RFC2426. Similar details for the vCalendar format may be found in the standards documents RFC2445, 2446, and 2447. As defined by the Internet Mail Consortium (IMC), vCard features include the following items:

Directory information such as name, address, e-mail address and relevant Internet Universal Resource Locators (URLs)

Multimedia information including photographs, company logos, audio clips, etc.

Geographic location information

Multiple language information

Similarly, vCalendar information may include scheduling appointment information relative to Personal Information Management (PIM) functions, and may further include “to-do” information and/or other task lists. Other standard data formats that may be specified and used for returned information provided by network 10 include Geo Tag data, which provides geographic-related information. Of course, other industry standards may be used for returning response information, and proprietary data formats may be used.

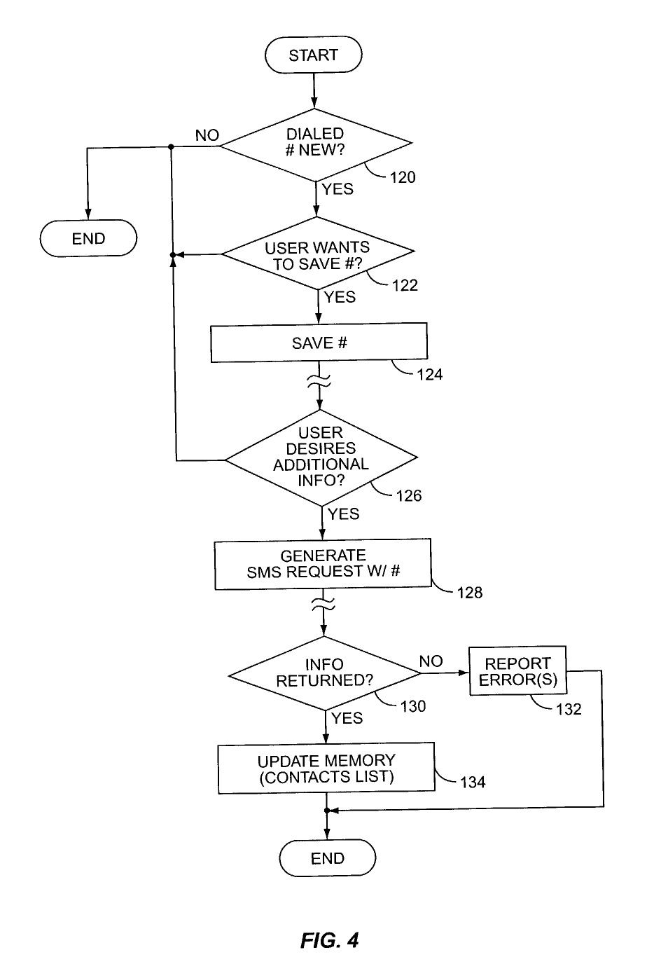

FIG. 4 illustrates an exemplary embodiment wherein the mobile station 12 assists the user in obtaining number-associated information for newly dialed telephone numbers. Processing begins with the mobile station 12 determining whether or not a number dialed by the user represents a “new” telephone number (Step 120). If the number is new, e.g., does not already exist in contact list 64, the mobile station 12 prompts the user to indicate whether the user wishes to save the telephone number (Step 122). Processing ends if the user does not wish to save the number, but if such storage is desired, mobile station 12 stores the number in memory 62, which may comprise generating a new contact record in the contacts list 64 stored in a non-volatile portion of memory 62 (Step 124).

At an appropriate time after saving the number, the mobile station 12 queries the user as to whether additional contact information is desired (Step 126). For example, the mobile station may wait until the end of the call to avoid distracting the user while the call is active. If the user indicates that additional information is desired, the mobile station 12 generates the appropriate SMS request that identifies or otherwise indicates the number of interest (Step 128) and transmits the request to the network as described above.

If the network 10 does not return information responsive to the request (Step 130), the mobile station 12 may report errors to the user as appropriate (Step 132) such as by displaying an error indicator on display 74. In at least some embodiments, the mobile station 12 maintains a response timer such that an error report is generated if the network 10 fails to respond to the request within a predetermined amount of time.

If the network 10 does return information, mobile station 12 may take any number of actions, including updating memory 62 by storing the returned information in a record associated with the phone number in the contacts list 64 (Step 134). In this respect, the database systems 22 or 24 accessed by SMSC 20 may comprise directory listing information, such as a “Yellow” or “White” pages database. In this manner, the user of mobile station 12 has the advantage of an automatically generated contact listing entry for a newly dialed number that includes whatever detailed directory information is available in network 10 for that number.

Generally, then, the present invention comprises a mobile-initiated SMS request for number-related data that allows the user of mobile station 12 to access and receive a variety of information associated with the phone number of interest. In one sense, this functionality provides the user with a fully featured “Reverse Directory Information” service, in which the user enters a number and receives from network 10 one or more data items associated with that number. While such data items have been identified as vCards and vCalendars and/or directory listing information, the present invention is not limited to such data items. Indeed, the number of interest may be a commercial number with which the associated vendor has enabled the delivery of coupons, which may be used by the user for purchasing goods or services from the vendor associated with the number of interest. Such coupons may be returned to the mobile station 12 in a variety of formats and stored in memory 62 for later presentation to the business in question. Indeed, the present invention further includes, in at least some embodiments, additional features that are of particular interest for commercial applications.

In one such embodiment, where the mobile station 12 originates a query associated with a commercial number, the vendor associated with that number is provided information regarding the identity and/or location of the requesting party so that it may more particularly target its advertising. Of course, the amount of identifying information released by the network 10 to a vendor associated with such queries may be controlled in accordance with any number of privacy policies implemented by the network service provider in association with agreed upon standards for release approved by individual users of mobile stations 12.

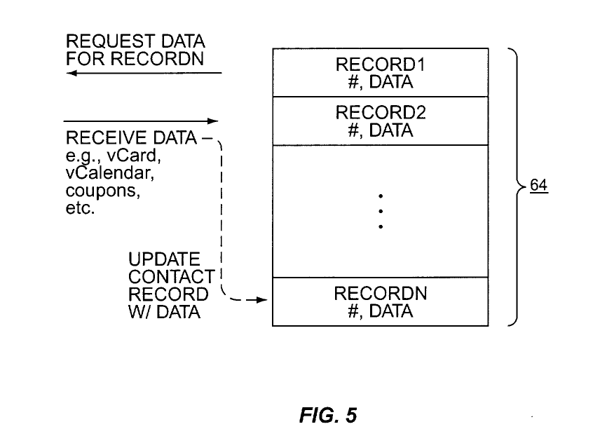

With the above variations in mind, FIG. 5 illustrates a generalized exemplary request/response operation, wherein the mobile station 12 originates the SMS request for data associated with an identified telephone number, and receives one or more data items from network 10 in a corresponding SMS response message. As previously discussed, such data items may comprise, but are not limited to, vCards, vCalendars, coupons, business descriptions, geographic information, detailed directions, restaurant menus, etc.

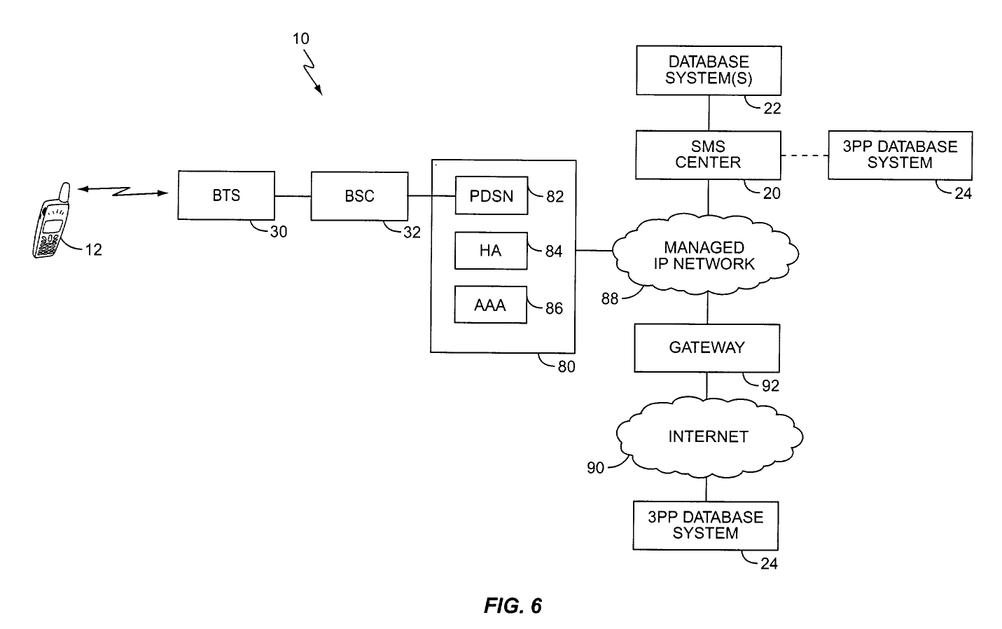

In addition to the many variations that may be practiced as regards generation of the request and formatting of the data and type of data that may be returned in the corresponding result, the present invention may be practiced across a wide variety of networks. Although the discussion began with an illustration of the present invention as might be practiced in a GSM-type network, FIG. 6 illustrates wireless communication network 10 implemented based on cdma2000 standards. Thus, the SMS-based messaging supporting the mobile-initiated number information request in accordance with the present invention may be implemented in packet data IP-based networks. Here, network 10 comprises the BTS 30, BSC 32, SMS-C 20, and database systems 22 and 24 as shown earlier in FIG. 1, although it should be understood that such entities are appropriately reconfigured for operation in accordance with the relevant CDMA standards.

Here, a Packet Core Network (PCN) 80, which comprises a Packet Data Serving Node (PDSN) 82, a Home Agent (HA) 84, and an Access Authorization Authentication (AAA) server 86, communicatively couples the mobile station 12 to a Managed IP Network 88, which couples to the Internet 90 through a gateway router 92. As illustrated, number-related information may be obtained by the network 10 using one or more of its own database systems 22, or may be obtained in cooperation with Third-Party Provider (3PP) database system 24, which may be coupled directly or indirectly to the SMS-C 20, or may be accessible to network 10 via the Internet 90.

As the above discussion and accompanying diagrams illustrate, the present invention is adaptable to a variety of network types and data formats. As such, the present invention is not limited by the exemplary details contained herein, but rather is limited only by the following claims and the reasonable equivalence thereof.

What is claimed is:

1. A method of retrieving one or more data items associated with a phone number from a wireless communication network comprising:
transmitting a short-messaging request from the mobile station to the wireless communication network, wherein the request includes a phone number for which additional information is desired;
receiving a short-messaging response from the network, wherein the response includes one or more data items associated with the phone number; and
updating a memory of the mobile station with the one or more data items received in the response.

2. The method of claim 1, wherein the one or more data items include directory listing information associated with the phone number.

3. The method of claim 2, wherein updating the memory of the mobile station comprises updating stored contact data such that the directory listing information is stored in association with the phone number.

4. The method of claim 2, wherein the phone number is a dialed number, and further comprising:
querying the user as to whether directory listing information is desired for the dialed number; and
performing the steps of transmitting, receiving, and updating if the directory information is desired for the dialed number; and
wherein the step of updating comprises saving the dialed number and the directory listing information in the stored contact data.

5. The method of claim 4 wherein the stored contact data comprises a contact list.

6. The method of claim 1, further comprising performing the steps of transmitting, receiving, and updating for one or more selected phone numbers in a contacts list stored in the memory of the mobile station, such that contact information for each selected phone number is updated with the one or more data items received for the selected phone number.

7. The method of claim 6, further comprising selecting the selected phone numbers based on identifying phone numbers in the contacts list that have incomplete contact information.

8. The method of claim 1, further comprising performing the step of transmitting the short-messaging request by:
recognizing that a user of the mobile station has dialed a phone number not currently stored in the mobile station;
determining whether the user desires directory information for the dialed phone number;
generating the short-messaging request to include a request for directory listing information for the dialed phone number; and
transmitting the short-messaging request to the network.

9. The method of claim 8, wherein receiving the short-messaging response from the network comprises receiving the directory listing information for the dialed number from the network.

10. The method of claim 9, wherein updating the memory of the mobile station comprises storing at least some of the directory listing information returned by the network in association with the dialed number.

11. The method of claim 10, wherein storing at least some of the directory listing information comprising storing the dialed number and the directory listing information in a contacts list held in the memory of the mobile station.

12. The method of claim 1, wherein transmitting the short-messaging request comprises:
generating a request in a short-messaging format supported by the network, wherein the request identifies a data format for the one or more data items to be returned by the network in the short-messaging response; and
transmitting the request to the network on a short-messaging channel supported by the network.

13. The method of claim 1, wherein transmitting the short-messaging request comprises transmitting a vCard request for directory information associated with the phone number.

14. The method of claim 13, wherein receiving the short-messaging response from the network comprises receiving a vCard corresponding to the vCard request.

15. The method of a claim 14, wherein updating the memory of the mobile station comprises adding the received vCard to a contacts list maintained in the memory of the mobile station.

16. The method of claim 1, wherein the phone number corresponds to a restaurant and the one or more data items in the short-messaging response comprise menu information for the restaurant, and wherein updating the memory comprising updating display memory such that the mobile station displays the menu information.

17. A wireless communication network to support phone-number related information requests from mobile stations, the network comprising:
one or more base stations to receive a short-messaging request from a mobile station and to transmit a corresponding short-messaging response, wherein the short-messaging request indicates a phone number for which additional information is desired and the short-messaging response comprises one or more data items associated with the phone number; and
a messaging center communicatively coupled to the one or more base stations to process the short-messaging request to determine the indicated phone number, and to generate the short-messaging response based on the network retrieving the one or more data items from at least one database accessible to the network.

18. The network of claim 17, wherein the at least one database comprises a directory information database.

19. The network of claim 18, wherein the directory information database includes name and address information for a plurality of telephone numbers, such that the one or more data items included in the short-messaging response returned to the mobile station includes directory information corresponding to the phone number indicated by the short-messaging request.

20. The network of claim 17, wherein the at least one database includes business information and wherein the short-messaging response includes corresponding business information if the indicated phone number is a commercial phone number included in the database of business information.

21. The network of claim 17, wherein the at least one database comprises a network database.

22. The network of claim 21, wherein the network database is communicatively coupled to the messaging center.

23. The network of claim 17, wherein the at least one database comprises an external database accessed by the network.

24. The network of claim 23, further comprising a database interface communicatively coupling the network to the external database.

25. The network of claim 24, wherein the messaging center includes the database interface.

26. The network of claim 17, wherein the messaging center comprises a computer system operative to process and generate short-messaging services messages within the network.

27. The network of claim 17, wherein the network comprises a GSM-based network.

28. The network of claim 17, wherein the network comprises a cdma2000-based network.

29. The network of claim 17, wherein the short-messaging request and response comprises short-messaging services (SMS) formatted messages.

30. The network of claim 17, wherein the short-messaging request indicates a desired format for return data to be included in the short-messaging response, and further comprising generating the short-messaging response to include the one or more data items according to the desired format.

31. The network of claim 30, wherein the desired format includes the vCard format, and wherein generating the short-messaging response to include the one or more data items according to the desired format comprises formatting at least one of the one or more data items as a vCard item.

32. The network of claim 30, wherein the desired format includes the vCalendar format, and wherein generating the short-messaging response to include the one or more data items according to the desired format comprises formatting at least one of the one or more data items as a vCalendar item.

33. The network of claim 30, wherein the desired format includes the Geo Tag format, and wherein generating the short-messaging response to include the one or more data items according to the desired format comprises formatting at least one of the one or more data items as a Geo Tag item.

34. A method of supporting mobile-initiated information queries in a wireless communication network comprising:
receiving a short-messaging request at the network from a mobile station, wherein the request indicates a phone number for which additional information is desired;
processing the request and retrieving one or more data items associated with the phone number in one or more databases accessible to the network; and
transmitting a short-messaging response including the one or more data items to the requesting mobile terminal.
